(19) United States
(12) Patent Application Publication
(10) Pub. No.: US 2013/0032542 A1
(43) Pub. Date: Feb. 7, 2013

(54) PERSONAL PORTABLE WATER PURIFICATION DEVICE

(71) Applicant: Moshe Golan, Arad (IL)

(72) Inventor: Moshe Golan, Arad (IL)

(21) Appl. No.: 13/641,486

(22) PCT Filed: Feb. 16, 2011
(86) PCT No.: PCT/IL11/00162

§ 371 Date: Oct. 16, 2012

Related U.S. Application Data
(60) Provisional application No. 61/342,519, filed on Apr. 16, 2010.

(51) Int. Cl. B01D 29/56; B01D 19/00; B01D 35/30; B01D 15/00

(52) U.S. Cl. 210/665; 210/295; 210/188; 210/232

(57) ABSTRACT

The emergency personal portable water purifying apparatus can be used by individuals to purify water that has become contaminated by natural or man-made disasters. The apparatus is lightweight, self-contained, fits on most standard bottlenecks by using an expanding sealing collar integrated into the purifier and needs to extra power supply. The water is forced through the filter by pressure on the sides of the bottle or suction from the mouthpiece. The water purifier has a water inlet with a residue collection area and quick fitting changeable mouthpiece valve on the water outlet. Water is flocculated and large particles, residue and sediments are contained in the particular residue collection area. Water then passes through the micron net to remove remaining particles and is forced through the active carbon chamber via the spiral form to the water outlet.

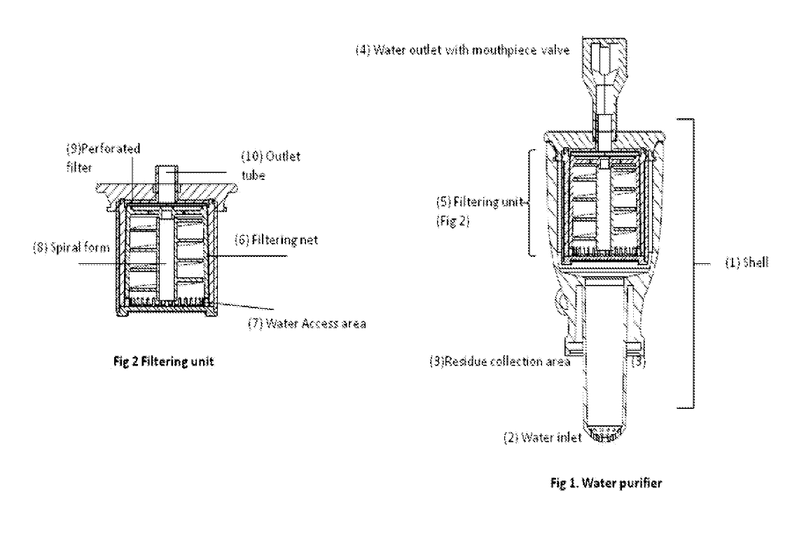

### PRIORITY INFORMATION

This National Stage Application claims priority to U.S. Provisional Application No. 61/342,519 filed Apr. 16, 2010 and PCT Application No. PCT/IL2011/000162 filed Feb. 16, 2011, and makes reference herein to each in its entirety.

### DESCRIPTION

2. Background

A human being cannot exist more than a few days under average conditions without clean drinking water. Water makes up 60% of the human body and is needed for circulation and other bodily functions. In the event of natural disasters such as earthquakes, typhoons, heavy rain and other catastrophes the infrastructure is likely to be compromised and the water supply contaminated.

The speed of restoring the clean drinking water supply is paramount for human survival. The personal water purifier will allow clean pleasant tasting drinking water to be available when disaster conditions do not allow drinking from normal sources. Water may be taken from contaminated sources and purified to an acceptable level. The personal water purifier can be used in emergency situations whenever drinking water sources are unfit for normal usage. Water may also be taken from lakes ponds puddles and similar water sources apart from water that is piped through the normal water system.

1. Technical field

This invention relates to personal portable water purifying systems and more particularly to a personal portable device that can be fitted to a bottle neck, is self contained and needs no extra power supply either supplied naturally or man-made.

### DESCRIPTION

The personal water purification device comprises of a plastic composite shell unit (1) with a preferably incorporated water inlet with holes of varying sizes (2) and residue collection area (3), and a purified water outlet (4) with quick fitting changeable seal-able mouthpiece valve 4) at the opposite end. The water purification shell unit is sealed.

Inside the water purification device shell is a water filtering unit (5) sealed from the outside environment and comprised of a filtering net (of varying sizes), an inner filter wall with access area (7) for water to enter the spiral form, (8) with active carbon, the perforated exit filter (9) and water outlet tube (10) for quick fitting mouthpiece valve. The personal water purification device can fit onto most bottles.

The water purifying device works in conjunction with a coagulating flocculation absorbent material which removes and or reduces the biological, chemical and organic (colloids) contaminates in the water. The water inlet section is designed with a residue collection area to help reduce, separate and inhibit residue and sediments from entering the water filtering section. The water then passes through the water chamber into the water filtering unit. The micron net removes the final micron sized particles from the water. The water continues through the active carbon filter where gases are adsorbed and removed. Bad tastes are also removed. The spiral form acts to increase the amount of time taken for the water to pass through the active carbon and increases the adsorption time of the active carbon. The quick fitting mouthpiece valve is fitted on the water outlet tube. The quick fitting mouthpiece valve is colored, removable and changeable for hygiene and multiple user purposes. When the outer walls of the valve are pressed together the valve is open and allows water to flow. When the outer walls are released and the valve closed, water can not pass through.

### Instruction Sheet

### Personal Portable Water Purification Device

A human being cannot exist more than a few days under average conditions without clean drinking water. Water makes up 60% of the human body and is needed for circulation and other bodily functions. In the event of natural disasters such as earthquakes, typhoons, heavy rain and other catastrophes the infrastructure is likely to be compromised and the water supply contaminated. The speed of restoring the clean drinking water supply is paramount for human survival. The personal water purifier Nahlapur will allow clean pleasant tasting drinking water to be available when disaster conditions do not allow drinking from normal sources. Water may be taken from contaminated sources and purified to an acceptable level.

### The Personal Portable Water Purifier

The intention of the personal portable water purifier is to purify contaminated bad tasting water to an acceptable level that so that it can be used in emergency situations where water is scarce. The water is filtered and purified by a coagulating flocculation material active carbon.

The personal water purification device uses a coagulating flocculation absorbent material which removes and or reduces the biological, chemical and organic contaminates in the water. It has three main parts. The outer shell with

1) Incorporated water inlet and residue collection area.
2) The internal water filter unit.
3) The quick fitting removable mouthpiece valve.

### Instructions for use.

The Nahlapur water purifier is to be used in emergency situations when the normal water supply is interrupted or compromised. Each water filter can be used for 550 litres of drinking water or until the flowing water does not taste fresh. The water is still safe to drink due to the coagulating flocculation material.

The water purifier is portable and easy to use. For hygiene purposes the quick fitting mouth piece valve can be changed by simply pulling off and replacing with another valve.

Items required for use:

A bottle, no larger than 1.0 litre, with bottleneck that will fit the water purifier. How to use the Nahlapur Water purifier:
Empty the coagulating flocculant sachet into the bottle.
Stir slowly for at least one (1) minute. Let the bottle rest for three (3) minutes
Fit the water purifier onto the bottle making sure the neck is well sealed.
Swirl the bottom of the bottle for 30 seconds. Wait for 7 minutes
The water can now be drunk from the purifier by tipping the bottle and opening the quick fitting mouthpiece by squeezing with the mouth or fingers.

I Claim: The personal water purification device uses a coagulating flocculation absorbent material which removes and or reduces the biological, chemical and organic contaminates in the water. It has four main parts. The outer shell with preferably 1) Incorporated water inlet and residue collection area, 2) the internal water filter unit, 3) the top cover, and 4) the quick fitting removable mouthpiece valve.

1. The water inlet and residue collection area reduce, separate and inhibit residue and sediments from entering the water filter and micron net to the extent they block the filter. The majority of residue and sediments remain in the residue collection area.

2. The use of a coagulating flocculation absorbent material coagulates most organic biological and chemical contaminates allowing them to be caught in the residue collection area.

3. The spiral form and active carbon increase the time water is kept in the filter allowing the carbon particles to adsorb gases.

4. The special quick fitting removable changeable mouthpiece valve allows the user to open, close and use the purified water stream at will.
